(19) United States
(12) Patent Application Publication
(10) Pub. No.: US 2023/0324698 A1
(43) Pub. Date: Oct. 12, 2023

(54) RUBBER CAMMING RATCHET FOR NEAR SILENT STRAP ADJUSTMENT

(71) Applicant: Meta Platforms Technologies, LLC, Menlo Park, CA (US)

(72) Inventors: Simon Morris Shand Weiss, Seattle, WA (US); Braxton Landess Lathrop, Lake Oswego, OR (US)

(21) Appl. No.: 17/719,168

(22) Filed: Apr. 12, 2022

(51) Int. Cl. G02B 27/01

(52) U.S. Cl. CPC G02B 27/0176

(57) ABSTRACT

A headset, e.g., an extended-reality headset, uses a ratcheting mechanism to tighten or loosen the headset. The ratcheting mechanism can include an adjusting knob including a wall, a toothed ring, and a rotating carrier including one or more pawls made from a flexible material. In examples, the flexible material can include at least one, or a combination of two or more, of thermoplastic polyurethane, low density polyethylene, silicone rubber, natural rubber, lower stiffness nylon, or other relatively elastomeric or pliant material. Rotating the adjusting knob causes one or more pawls to disengage from teeth of the toothed ring with a reduced clicking sound (e.g., at a lower decibel level) based at least in part on the flexible material of the pawl. In some examples, rotating the adjusting knob can cause a pawl neck to buckle and rotate such that the pawl wedges between the rotating carrier and the toothed ring.

### BACKGROUND

Recent years have seen significant advancement in extended-reality experiences. Indeed, extended reality (e.g., virtual reality, augmented reality, mixed reality, etc.) has grown in popularity, and technological advancements have facilitated its use in a variety of applications, such as gaming, online shopping, military training, and tourism. However, conventional hardware, such as conventional headsets worn when participating in extended-reality environments, use a ratcheting mechanism with internal pieces made from hard plastic to loosen or tighten the headset. This hard plastic creates a great deal of noise when a user tightens or loosens the headset partly due to biasing of the relatively hard plastic pawls clicking against teeth of the ratchet and impacting the teeth of the ratchet during loosening. This loud noise detracts from the user experience, particularly the user experience provided by extended-reality systems, especially when a user adjusts the size of the headset while wearing it.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 illustrates a 3-D side view of a headset including an example ratcheting mechanism, shown in the excerpted view, in accordance with one or more examples of the present disclosure.

FIG. 2 illustrates an example ratcheting mechanism.

FIGS. 3A and 3B illustrate examples where a neck of a pawl is notched or thinned in order to facilitate a controlled bending at a specific location of the neck of the pawl.

FIG. 4 includes a flow chart of an example process for tightening or loosening a strap adjustment with corresponding examples illustrating operation of a ratcheting mechanism according to the present disclosure.

FIG. 5 includes a flow chart of an example process for tightening or loosening a strap adjustment opposite of FIG. 4, with corresponding examples illustrating operation of a ratcheting mechanism according to the present disclosure.

### DETAILED DESCRIPTION

Conventional headsets, including extended-reality headsets, rely on a ratcheting mechanism to tighten or loosen a strap around the user's head. However, such conventional headsets use a ratcheting mechanism with internal pieces made from a hard plastic. This hard plastic creates a great deal of noise when a user tightens or loosens the headset partly due to biasing of the relatively hard plastic pawls clicking against teeth of the ratchet and impacting the teeth of the ratchet during loosening. There is a need for a quieter ratcheting mechanism to avoid detracting from a user's extended-reality experience when adjusting the size of a headset, including an extended-reality headset, while a user is wearing the headset.

As used herein, the term “extended-reality headset” refers to a computing device having extended-reality capabilities and/or features. In particular, an extended-reality headset can refer to a computing device that can present an extended-reality graphical user interface. An extended-reality headset can further display one or more visual elements within the extended-reality graphical user interface and receive user input that targets those visual elements. For example, an extended-reality headset can include, but is not limited to, a virtual reality device, an augmented reality device, or a mixed reality device. In particular, an extended-reality device can include any device capable of presenting a full or partial extended-reality environment. Nonlimiting examples of extended-reality headsets can be found throughout this application.

In examples, a headset, including an extended-reality headset, includes an external frame which can be substantially rigid and can define a general exterior shape of the headset. In at least one example, the external frame can have a first side piece and/or a second side piece coupled to the external frame.

A headset, including an extended-reality headset, can also include a flexible strap. The flexible strap can be located inside the external frame and can be formed from one or more elastomeric materials, including relatively hard elastomeric materials such as polyamide, polypropylene, polyurethane and/or polyethylene, etc. and/or relatively soft materials such as a natural material (e.g., rubber, silk, cork, wool, felt, etc.), or a synthetic material (e.g., styrene-butadiene block copolymers, polyisoprene, ethylene propylene rubber, ethylene propylene diene rubber, silicone elastomers, fluoroelastomers, polyurethane elastomers, and nitrile rubbers, neoprene, polyester, etc.).

A headset can include a ratcheting mechanism also referred to herein as a “tensioning mechanism,” to adjust the size of the flexible strap (i.e., tighten and/or loosen the flexible strap). The ratcheting mechanism can include an adjusting knob, a wall coupled to the adjusting knob, a toothed ring, and a rotating carrier including one or more pawl(s). A pawl can include a pawl head and a pawl neck. In examples, a pawl can be formed from a flexible material. The flexible material can include, in examples, at least one, or a combination of two or more, of thermoplastic polyurethane, a low-density polyethylene, a low stiffness plastic, a natural rubber, a silicon rubber, a low stiffness nylon, or other relatively elastomeric or pliant material. When formed from a flexible material, the flexible material enables the pawl to avoid producing a clicking sound as the pawl disengages or engages with teeth of a toothed ring. For example, the flexible material can decrease the decibel level or any clicking associated with the disengagement or engagement of the pawl with teeth of a toothed ring.

This application describes techniques for tightening and/or loosening a headset via a ratcheting mechanism. In at least one example, to loosen the headset, a user may rotate an adjusting knob associated with the ratcheting mechanism in a first direction (e.g., counterclockwise). In some examples, rotating the adjusting knob in the first direction causes a wall coupled to the adjusting knob to push outward toward a pawl. Based at least in part on the wall pushing outward toward a pawl, a neck of the pawl is pushed inward toward a center of the ratcheting mechanism. Pushing the pawl inward may cause the pawl head to disengage from the teeth of a stationary toothed ring. In some examples, the wall pushing outward toward a pawl may cause the pawl neck of the pawl to buckle and cause the pawl to wedge between the rotating carrier and the toothed ring in a way that enables the rotating carrier to rotate in the first direction and loosen the headset.

The ratcheting mechanism may also enable a user to tighten the headset. For example, a user may rotate the adjusting knob of the ratcheting mechanism in a second direction (e.g., clockwise). Rotating the adjusting knob in the second direction may cause a wall to move outward and push against a shoulder of the rotating carrier. The shoulder of an inner rotating carrier may be adjacent the proximal end of the pawl. The wall pushing against the shoulder of the rotating carrier may cause the rotating carrier to move in the second direction and cause the headset to be tightened.

These and other aspects are described further below with reference to the accompanying drawings. The drawings merely illustrate examples and should not be construed to limit the scope of the claims. For example, while examples are illustrated in the context of an extended-reality headset, the techniques can be applicable to other headset devices.

### Example Device and Process

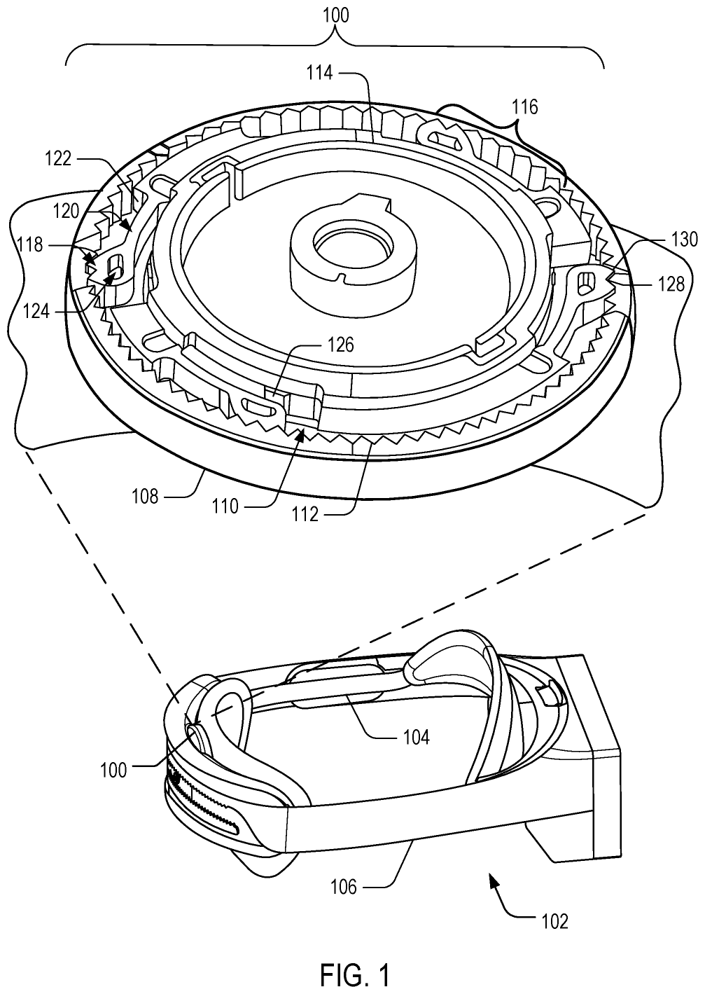

FIG. 1 illustrates a 3-D side view of an example ratcheting mechanism 100 in accordance with one or more examples of the present disclosure. Although the disclosure provides description of a ratcheting mechanism 100 as part of a headset 102 (e.g., an extended-reality headset) operatively coupled to a flexible strap 104, it is to be understood that the ratcheting mechanism 100 may be included in any suitable clothing, accessory, or other item with adjustable features. For example, the ratcheting mechanism 100 described herein may be included in shoes/footwear, pants (e.g., with a waistband), hats, helmets, shirts, dresses, or any other product having adjustable sizing. In examples like the one illustrated, the ratcheting mechanism 100 can be coupled to a flexible strap 104. In the illustrated example, the ratcheting mechanism 100 is positioned in a substantially center region of the rear of a headset 102. In various examples, ratcheting mechanism 100 may be positioned or located in any suitable position on the headset 102. In some examples, the ratcheting mechanism can be positioned in a front or side of the headset 102.

In examples, the headset 102 can include a flexible strap 104. In examples, the flexible strap 104 can be located inside an external frame 106 of the headset 102, such that the flexible strap 104 is located between the external frame 106 and a user's head when the user is wearing the headset 102. In some examples, the ratcheting mechanism 100 can be positioned substantially closer to a location of a user's head when a user is wearing the headset 102. In some examples, the ratcheting mechanism 100 can be positioned substantially away from a location of a user's head when a user is wearing the headset 102 (e.g., closer to an external frame 106). A flexible strap 104 can be operably coupled to an external frame 106 of the headset 102. A flexible strap 104 in cooperation with ratcheting mechanism 100 can configure the headset 102 to be secured to the head of a user.

While the flexible strap 104 is depicted as being one strap, multiple flexible straps may be configured in some instances. For example, the flexible strap 104 may be a first flexible strap, and the headset 102 may further include a second flexible strap (not pictured), which may operate in parallel, perpendicular to, or at another angle to the flexible strap 104. In some examples, a first flexible strap and/or a second flexible strap may include terminating ends with a plurality of teeth.

In some examples, the external frame 106 of the headset 102 and the flexible strap 104 can be adjustable via a ratcheting mechanism 100 in order to fit a head shape and size of any user and/or to stabilize the display structure relative to the head of a user, respectively.

A ratcheting mechanism 100 can include an adjusting knob 108, a wall 110 coupled to the adjusting knob 108, a toothed ring 112, and a rotating carrier 114 associated with one or more pawl(s) 116. A pawl 116 can include a pawl head 118, a pawl neck 120, and a shoulder 122 of a rotating carrier 114. In some examples, the pawl head 118 can include an opening 124. The rotating carrier 114 can include a raised platform 126 near a distal end of a pawl head 118.

In some examples, the ratcheting mechanism 100 can operate or be controlled via an adjusting knob 108. In some examples, the adjusting knob 108 can be configured to rotate in one or more directions. In some examples, the adjusting knob 108 can function as a housing for the ratcheting mechanism 100. The adjusting knob 108 can be configured to rotate (e.g., to be rotated by a mechanism and/or user) in order to tighten or loosen a headset 102 relative to a wearer's head.

In examples, the adjusting knob 108 can be configured with an associated wall 110, which can have a ramp shape in some examples. In some examples, the wall 110 can be located around a circumference of the adjusting knob 108. In at least one example, the wall 110 may be made up of one or a plurality of individual pieces that are located intermittently, sporadically, consistently, or inconsistently around a circumference of the adjusting knob 108. In some examples, adjusting knob 108 can function as housing or a part of the housing for ratcheting mechanism 100. In various examples, the adjusting knob 108 can be formed from one or more substantially rigid or semi-rigid polymers (e.g., polycarbonate, acrylonitrile-butadiene-styrene (ABS), polycarbonate/acrylonitrile-butadiene-styrene terpolymer blend (PC/ABS), polycarbonate-ABS, acrylic, nylon, polyvinyl chloride (PVC), high-density polyethylene (HDPE), etc.).

In some examples, a toothed ring 112 can be coupled to the headset in a configuration to facilitate keeping the toothed ring 112 substantially stationary as the adjusting knob 108 rotates. In some examples, the toothed ring 112 can circumscribe the housing of the ratcheting mechanism 100. In some examples, the toothed ring 112 can comprise of a plurality of protrusions or teeth that protrude toward a center of the ratcheting mechanism 100. For example, the teeth of the toothed ring 112 can extend in the direction of the rotating carrier 114. The teeth of the toothed ring 112 can act to fix the rotating carrier 114 in a position by interacting with one or more indentations 128 and/or protrusions 130 located on one or more pawl head(s) 118 when a size of the headset is not being adjusted. In some examples, the teeth of the toothed ring 112 are uniformly sized and/or spaced or non-uniformly sized and/or spaced. In some examples, the toothed ring 112 can be made of a flexible material. For example, the flexible material can include at least one, or a combination of two or more, of thermoplastic polyurethane, a low-density polyethylene, a low stiffness plastic, a natural rubber, a silicon rubber, a low stiffness nylon, or other relatively elastomeric or pliant material. The flexible material may decrease the level of sound (e.g., decrease the decibel level) associated with a pawl head 118 disengaging and engaging with the teeth of the toothed ring 112. In some examples, the teeth of the toothed ring 112 may be lined with a flexible material that can include at least one, or a combination of two or more, of thermoplastic polyurethane, a low-density polyethylene, a low stiffness plastic, a natural rubber, a silicon rubber, a low stiffness nylon, or other relatively elastomeric or pliant material.

In some examples, a rotating carrier 114 is rotatably coupled to the adjusting knob 108. The rotating carrier 114 can include at least one pawl 116. In the particular example shown in FIG. 1, the rotating carrier 114 includes four pawls 116. However, in various examples, a lesser or greater number of pawls may be coupled to the rotating carrier 114. In some examples, the pawls 116 may face a same direction. In some examples, the size, shape, and/or orientation of one or more pawls may vary. When the adjusting knob 108 is not being rotated, the pawl head 118 is in physical contact with the toothed ring 112 in order to maintain a desired headset size.

A pawl 116 can include a pawl head 118, a pawl neck 120, and be associated with a shoulder 122 of a rotating carrier. A shoulder 122 of a rotating carrier can be located adjacent a proximal end of a pawl 116. The pawl 116 can be made of a flexible material. The flexible material may help decrease the level of sound (e.g., decrease the decibel level) associated with a pawl disengaging and engaging with the teeth of the toothed ring 112.

In some examples, the pawl head 118 can include one or more indentation(s) 128 and/or protrusion(s) 130 located on a lateral end of the pawl head 118. In some examples, an indentation 128 on the lateral end of the pawl head 118 can be sized to accommodate the diameter of the teeth of the toothed ring 112. In some examples, one or more protrusion(s) 130 on a pawl head 118 can be sized to accommodate the diameter between two teeth of the toothed ring 112. When the adjusting knob 108 is not actively being rotated, the pawl head 118 is in physical contact with the toothed ring 112 in order to prevent the rotating carrier 114 from moving relative to the adjusting knob 108.

In some examples, the pawl head 118 can include a hollow region in place of opening 124. For example, rather than an opening 124, (e.g., a hole, a cut-out, etc.), a hollow region may include an area that has a reduced thickness compared to other parts of the pawl head 118. An opening 124 or hollow region can be located in a center of the pawl head 118, or in a central area of the pawl head 118. In some examples, an opening 124 or hollow region can extend past the edge of the pawl head 118 such that relatively thicker material of the pawl head 118 does not enclose the sides of the opening 124 or hollow region.

In some examples, the pawl may be about 13.5 millimeters in length (e.g., including the pawl head and neck). In some examples, the pawl head 118 is generally oblong (e.g., oval shaped) with a short dimension and a long dimension. In some examples, the short dimension of the pawl head 118 can be oriented tangential to the direction of rotation. In some examples, the pawl neck 120 has a length that is greater than the length of the long dimension of the pawl head 118. In some examples, the pawl neck 120 can be substantially the same length as the long dimension of the pawl head 118. In some examples, the pawl neck 120 can be shorter in length than the long dimension of the pawl head 118.

In some examples, the toothed ring 112 is positioned approximately 4.5 millimeters from the rotating carrier 114.

In examples, the pawl neck 120 may include an articulating area, e.g., a notch, a thinned area, a hinge, etc. to facilitate a controlled bending or buckling of the pawl neck 120. In various examples, relative to the rotating carrier 114, an articulating area may be located at an exterior portion of the pawl neck 120 and/or an interior portion of the pawl neck 120.

In some examples, the rotating carrier 114 can include one or more raised platform(s) 126. In some examples, a raised platform 126 can be positioned under a distal end of a pawl head 118, e.g., a part of the rotating carrier 114 can be raised and positioned under a pawl head 118. A raised platform 126 can facilitate and/or encourage the bending of a pawl 116. A raised platform 126 can also function to control a pawl head's 118 range of motion during loosening or tightening of the headset 102 (i.e., decrease the downward movement of a pawl head 118 as the pawl head disengages from a toothed ring 112). For example, when the size of the headset 102 is being adjusted, a raised platform 126 may facilitate or encourage the pawl neck 120 to bend in a particular way or at a particular location, e.g., at an articulating area.

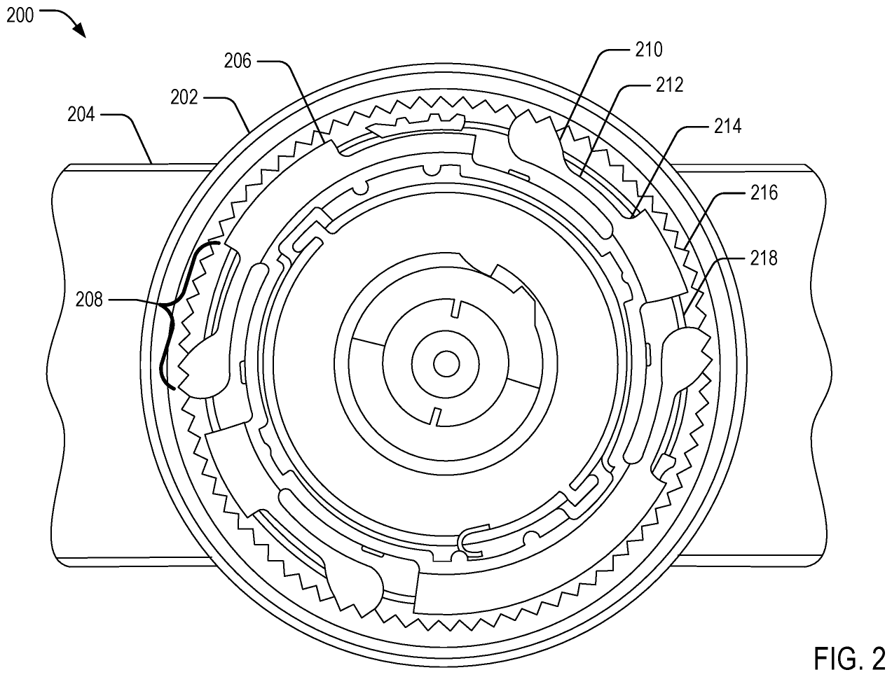

FIG. 2 illustrates an example ratcheting mechanism 200, which can generally correspond to ratcheting mechanism 100, as introduced in FIG. 1. As illustrated, ratcheting mechanism 200 can be associated with headwear such as a headset 102, as introduced in FIG. 1. Ratcheting mechanism 200 may be associated with an adjusting knob 202, which can generally correspond to adjusting knob 108, as introduced in FIG. 1. In some examples, adjusting knob 202 may function as part of the housing for the ratcheting mechanism 200.

In the example FIG. 2 illustrates, ratcheting mechanism 200 includes an adjusting knob 202 to adjust the size of a flexible strap 204, which can correspond to flexible strap 104, as introduced in FIG. 1. The ratcheting mechanism 200 includes a rotating carrier 206, which can generally correspond to rotating carrier 114, as introduced in FIG. 1. The ratcheting mechanism 200 includes at least one pawl 208 coupled to a rotating carrier 206. Pawl 208 can generally correspond to pawl 116, as introduced in FIG. 1. As illustrated, pawl 208 includes a pawl head 210 and a pawl neck 212, proximate a shoulder 214 of rotating carrier 206. The ratcheting mechanism 200 includes a toothed ring 216, which can generally correspond to toothed ring 112, as introduced in FIG. 1. The ratcheting mechanism 200 includes a wall 218, which can generally correspond to wall 110, as introduced in FIG. 1. In some examples, wall 218 can have a ramp shape.

In some examples, flexible strap 204 can be located inside an external frame of a headset, such as headset 102. In these examples, flexible strap 204 is located between an external frame and the head of a user when the user is wearing the headset. Flexible strap 204 can be coupled to the external frame. Flexible strap 204 can configure a headset, such as headset 102, to be secured to the head of a user when the user is wearing a headset.

Rotating carrier 206 can include at least one pawl 208. In some examples, rotating carrier 206 can include a plurality of pawls 208. In some examples, a plurality of pawl(s) 208 may face a same direction. In some examples, the size, shape, and/or orientation of one or more pawls may vary. Rotating carrier 206 remains in a substantially fixed position unless the adjusting knob 202 rotates in order to maintain a desired headset size.

In various examples, pawl 208 can be made of a flexible material, which can include at least one, or a combination of two or more, of thermoplastic polyurethane, a low-density polyethylene, a low stiffness plastic, a natural rubber, a silicon rubber, a low stiffness nylon, or other relatively elastomeric or pliant material.

As illustrated, pawl 208 includes a pawl head 210 and a pawl neck 212. In some examples, the pawl head 210 can include an indentation sized to accommodate the dimensions of the teeth of the toothed ring 216 in order to prevent movement of the rotating carrier 206 relative to the adjusting knob 202 being stationary. In some examples, though not shown in FIG. 2, a pawl head 210 can include an opening or hollow region corresponding to opening 124 as shown in FIG. 1. In some examples, an opening or hollow region can be located in a center or central area of the pawl head 210. In some examples, the opening or hollow region can extend past an edge of the pawl head 210 such that relatively thicker material of the pawl head 210 does not enclose the sides of the opening or hollow region.

In some examples, the pawl head 210 is generally oblong (e.g., oval shaped) with a short dimension and a long dimension. In some examples, the short dimension can be oriented tangential to the direction of rotation.

In some examples, the pawl neck 212 has a length that can be greater than the length of the long dimension of the pawl head 210. In some examples, the pawl neck 212 can be the same length as the long dimension of the pawl head 210. In some examples, the pawl neck 212 can be shorter in length than the long dimension of the pawl head 210. In some examples, the pawl neck 212 is associated with a shoulder 214 of a rotating carrier 206. The shoulder 214 of the rotating carrier may be adjacent the proximal end of the pawl 208.

The toothed ring 216 can include a plurality of protrusions or teeth. The toothed ring 216 can be coupled to the ratcheting mechanism 200 in a configuration to facilitate the toothed ring 216 remaining substantially stationary when the adjusting knob 202 rotates. A plurality of teeth on a surface, e.g., outer surface, of the toothed ring 216 may be configured to interact (e.g., engage) with a pawl 208 coupled to the rotating carrier 206. The teeth on the toothed ring 216 may extend in one or more directions. In some examples, the teeth of the tooth ring 216 can be configured with spacing to accommodate protrusions and/or indentations on a pawl head 210.

In some examples, adjusting knob 202 can function as housing or a part of the housing for the ratcheting mechanism 200. In some examples, the adjusting knob 202 is operably coupled to or includes wall 218. Rotating the adjusting knob 202 can push the wall 218 outward toward one or more pawl(s) 208. In some examples, the wall 218 is located around a circumference of the adjusting knob 202. In examples, the wall 218 may be made up of one or a plurality of individual pieces that operate in unison and are located intermittently, sporadically, consistently, or inconsistently around a circumference or throughout a portion of the adjusting knob 202 or the ratcheting mechanism 200.

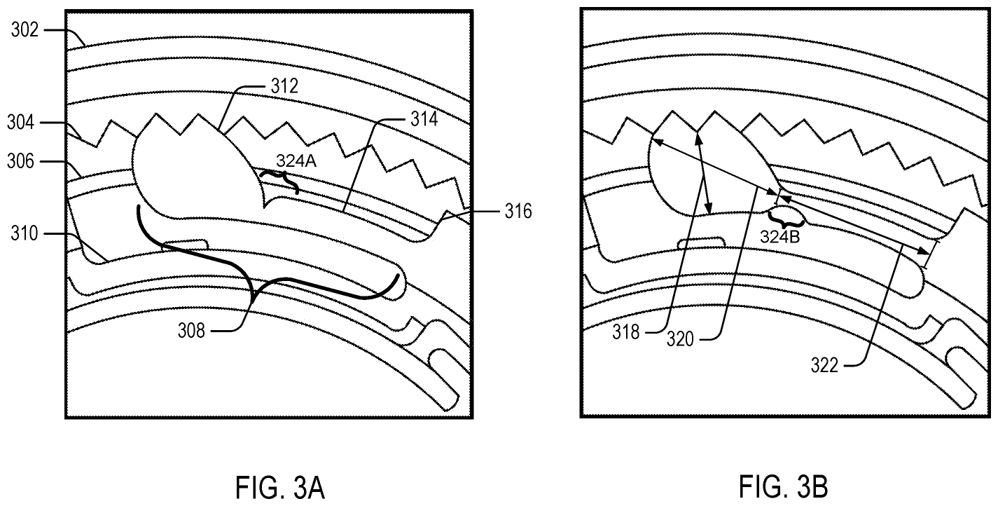

FIGS. 3A and 3B illustrate example pawls, which can generally correspond to pawl 208 in example ratcheting mechanism 200 as introduced in FIG. 2. For example, the ratcheting mechanism can include an adjusting knob 302 (e.g., an outer adjusting knob), a toothed ring 304 (e.g., an outer toothed ring), a wall 306 coupled to the adjusting knob 302, a pawl 308 coupled to a rotating carrier 310 (e.g., an inner rotating carrier). Individual pawls can include a pawl head 312 and a pawl neck 314. In some examples, the pawl neck 314 is associated with a shoulder 316 of a rotating carrier 310. The shoulder 316 of a rotating carrier 310 may be adjacent a proximal end of a pawl 308.

In some examples, a pawl head 312 can be generally oblong (e.g., oval shaped) with a short dimension 318 and a long dimension 320, where the short dimension 318 can be oriented tangential to a direction of rotation (e.g., tangential to a clockwise or counterclockwise rotation). In some examples, the pawl neck 314 has a length 322 that can be greater than the length of the long dimension 320 of the pawl head 312. In some examples, the pawl neck 314 can be generally the same length as the long dimension 320 of the pawl head 312. In some examples, the pawl neck 314 can be shorter in length than the long dimension 320 of the pawl head 312.

The example pawls shown in FIGS. 3A and 3B show examples of a pawl neck 314 having an articulating area 324, e.g., a notch, a thinned area, a hinge (not shown) etc. to facilitate a controlled bending or buckling of the pawl neck at a specific location. In various examples, a pawl 308 can be configured with an articulating area 324A and/or articulating area 324B in a superior portion and/or an inferior portion of a pawl neck 314. For example, FIG. 3A illustrates an articulating area 324A having a concave shape located on a superior portion of a pawl neck 314. FIG. 3B illustrates an articulating area 324B having a convex shape located on an inferior portion of a pawl neck 314. Example articulating areas 324A and 324B can be configured to facilitate a controlled bending of a pawl neck 314 associated with rotating an adjusting knob 302. For example, a user may want to adjust a size of a headset via a ratcheting mechanism.

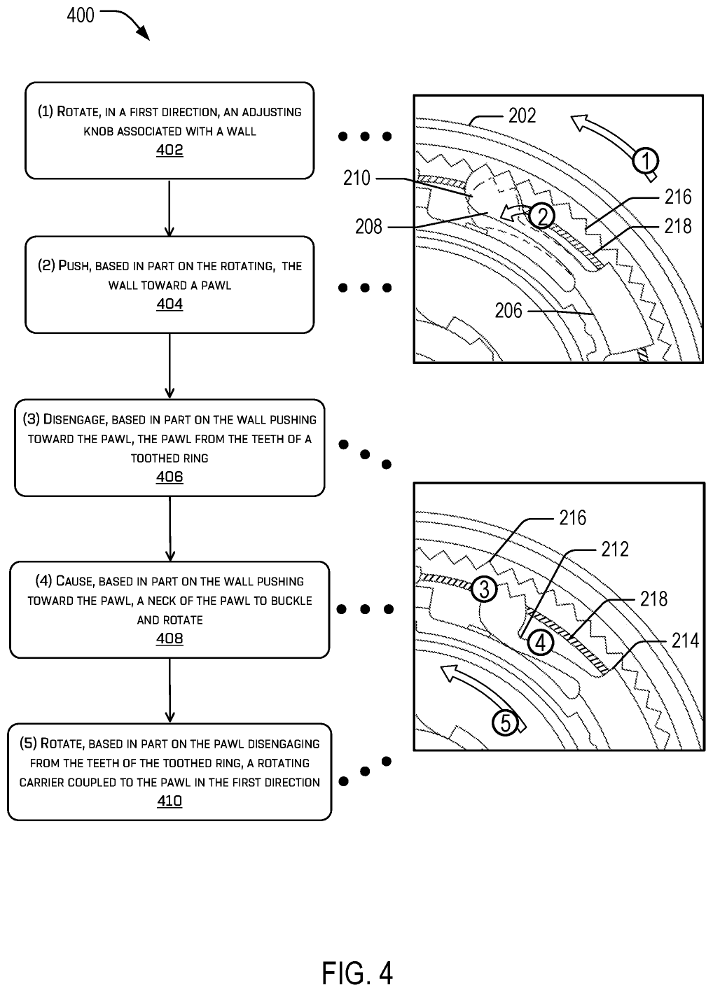

FIG. 4 illustrates an example process for tightening or loosening a flexible strap using a ratchet mechanism with a flowchart 400 and illustrations of corresponding example structures introduced in FIG. 2. At block 402, the process includes an adjusting knob 202 rotating in a first direction. In some examples, the first direction can be a counterclockwise direction or a clockwise direction. In some examples, rotating the adjusting knob 202 in the first direction (e.g., counterclockwise) can be associated with loosening a flexible strap coupled to a headset. The adjusting knob 202 can include a wall 218. In some examples, the adjusting knob 202 can rotate in a second direction (e.g., clockwise) where rotating the adjusting knob 202 in the second direction tightens a strap adjustment coupled to a headset.

At block 404, the process includes based at least in part on the adjusting knob 202 rotating in the first direction, the ratcheting mechanism 200 associated with the adjusting knob 202 pushing the wall 218 toward a pawl 208 to disengage the pawl 208 (i.e., a pawl head 210) from a tooth or teeth of the toothed ring 216. In some examples, the wall 218 can push outward toward a pawl 208; in some examples, the wall 218 can push inward toward a pawl 208. In some examples, the toothed ring 216 can remain substantially stationary as the adjusting knob 202 rotates in a first or second direction. For example, the toothed ring 216 can remain substantially stationary while the pawl 208 coupled to the rotating carrier 206 engages or disengages from the toothed ring 216.

At block 406, the process includes a pawl head 210 disengaging from teeth of a toothed ring 216, based at least in part on a wall 218 pushing against a pawl 208. In some examples, to disengage a pawl head 210 from the toothed ring 216, the wall 218 can push a pawl 208 inward toward a center of a ratcheting mechanism 200; in some examples, the wall 218 can push a pawl 208 upward. The pawl 208 can flex toward a center of the ratcheting mechanism 200 (e.g., toward the rotating carrier 206) in order to create a clearance between the pawl head 210 and the toothed ring 216 so that the pawl 208 is no longer engaged with the teeth of the toothed ring 216.

At block 408, the process includes, based in part on a wall 218 pushing against a pawl 208, a pawl neck 212 of the pawl 208 bending or buckling. In some examples, the pawl neck 212 of the pawl 208 can be configured to facilitate a controlled bending or buckling at a specific location. For example, the pawl neck can include an articulating area located on an inferior and/or superior portion of a pawl neck 212. In some examples, an articulating area can include one or more of a notch, a thinned area, a cut-out or hollow region, or a hinge to facilitate controlled bending or buckling at a general or specific area. In some examples, the pawl neck 212 of the pawl 208 can bend or buckle in a way that causes a pawl head 210 to wedge between the toothed ring 216 and the rotating carrier 206.

At block 410, the process includes a rotating carrier 206 rotationally coupled to the adjusting knob rotate in the first direction, based in part on the pawl head 210 disengaging from the tooth or teeth of the toothed ring 216. In some examples, the rotating carrier 206 rotating in the first direction (e.g., counterclockwise) is associated with loosening a headset.

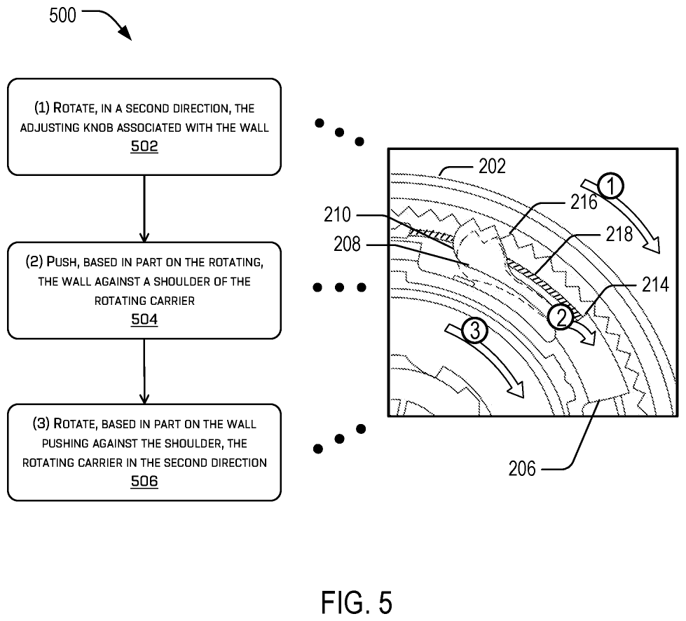

FIG. 5 illustrates an example process for tightening or loosening a flexible strap using a ratchet mechanism with a flowchart 500 and illustrations of corresponding example structures introduced in FIG. 2. FIG. 5 illustrates a reverse process to that of FIG. 4. At block 502, the process includes rotating an adjusting knob 202 associated with the ratcheting mechanism in a second direction (as compared to the first direction of FIG. 4). In some examples, the second direction can be a clockwise direction. The adjusting knob 202 includes a wall 218 that can move toward one or more pawls 208 as the adjusting knob 202 rotates in the second direction.

At block 504, the process includes, based in part on the adjusting knob 202 rotating in the second direction, a wall 218 pushing against a shoulder 214 of a rotating carrier 206. The shoulder 214 of the rotating carrier 206 can be adjacent a proximal end of a pawl 208 and coupled to the rotating carrier 206.

At block 506, the process includes, based in part on a wall 218 pushing against a shoulder 214 of a rotating carrier 206, the rotating carrier 206 rotating in the second direction and causing a pawl head 210 to skip along the teeth of a toothed ring 216. In some examples, the rotating carrier 206 rotating in the second direction (e.g., clockwise) is associated with tightening a headset.

### CONCLUSION

Although the discussion above sets forth example implementations of the described techniques, other architectures can be used to implement the described functionality and are intended to be within the scope of this disclosure. Furthermore, although the subject matter has been described in language specific to structural features and/or methodological acts, it is to be understood that the subject matter defined in the appended claims is not necessarily limited to the specific features or acts described. Rather, the specific features and acts are disclosed as example forms of implementing the claims.

What is claimed is:

1. A headset comprising:
a flexible strap associated with the headset;
a tensioning mechanism coupled to the flexible strap and configured to adjust a size of the headset; the tensioning mechanism comprising:
a rotating carrier including one or more pawls, wherein:
a pawl of the one or more pawls comprises a pawl head and a pawl neck, and
the pawl neck is formed from a flexible material adapted to reduce sound when the rotating carrier rotates;
a toothed ring comprising a plurality of teeth protruding toward the rotating carrier; and
a knob including a wall configured to disengage the pawl head from the teeth of the toothed ring when the knob is rotated in a first direction.

2. The headset of claim 1, wherein the flexible material includes at least one of:
a low-density polyethylene;
a low stiffness plastic;
a natural rubber; or
a silicon rubber.

3. The headset of claim 1, wherein the pawl head has a long dimension and a short dimension, wherein the short dimension is oriented tangential to a direction of rotation.

4. The headset of claim 3, wherein the pawl neck is longer than the long dimension of the pawl head.

5. The headset of claim 1, wherein the rotating carrier includes a shoulder adjacent a proximal end of the pawl.

6. The headset of claim 5, wherein the shoulder of the rotating carrier is configured such that rotating the knob in a second direction causes:
the wall to push against the shoulder of the rotating carrier,
the rotating carrier to rotate in the second direction, and
the flexible strap to tighten.

7. The headset of claim 1, wherein the knob is configured to:
rotate a second direction to cause the wall to push the pawl head to disengage from the teeth of the toothed ring, and
cause the pawl neck of the pawl to buckle and wedge between the rotating carrier and the toothed ring.

8. The headset of claim 1, wherein the pawl neck is configured to facilitate controlled bending at a specific location.

9. The headset of claim 1, wherein the pawl neck includes an articulating area.

10. The headset of claim 1, wherein the pawl head includes an opening or a hollow region.

11. A tensioning mechanism comprising:
a rotating carrier including a plurality of pawls comprising a flexible material adapted to reduce sound when the rotating carrier rotates, a pawl of the plurality of pawls having a pawl head and a pawl neck;
a toothed ring; and
an adjusting knob including a wall configured to at least one of:
push the pawl to disengage from teeth of the toothed ring, or
pull the pawl to engage with the teeth of the toothed ring.

12. The tensioning mechanism of claim 11, wherein the flexible material includes at least one:
a low-density polyethylene;
a low stiffness plastic;
a natural rubber; or
a silicon rubber.

13. The tensioning mechanism of claim 11, wherein the pawl head has a long dimension and a short dimension, wherein the short dimension is oriented tangential to a direction of rotation.

14. The tensioning mechanism of claim 13, wherein the pawl neck is longer than the long dimension of the pawl head.

15. The tensioning mechanism of claim 11, wherein the adjusting knob is configured to:
rotate in a first direction to cause the wall to push the pawl to disengage from the teeth of the toothed ring and
cause the pawl neck of the pawl to buckle and wedge between the rotating carrier and the toothed ring.

16. The tensioning mechanism of claim 15, wherein the adjusting knob is configured to:
rotate in a second direction to cause the wall to push against a shoulder of the rotating carrier, wherein the shoulder of the rotating carrier is adjacent a proximate end of the pawl, and
cause the rotating carrier to rotate in the second direction to tighten a fit of a headset.

17. The tensioning mechanism of claim 11, wherein the pawl neck includes an articulating area to facilitate a controlled bending at a specific location.

18. A method comprising:
rotating an adjusting knob, the adjusting knob including a wall; and
based on the rotating, engaging or disengaging a pawl of flexible material with teeth from a toothed ring, wherein the flexible material reduces sound from the engaging or disengaging of the pawl with the teeth;
pushing, based in part on rotating the adjusting knob, the wall toward the pawl;
disengaging, based in part on the wall pushing toward the pawl, the pawl from the teeth of a toothed ring;
causing, based in part on the wall pushing toward the pawl, a neck of the pawl to buckle and wedge between a rotating carrier and the toothed ring; and
rotating, based in part on the pawl disengaging from the teeth of the toothed ring, the rotating carrier coupled to the pawl.

19. The method of claim 18, wherein the flexible material includes at least one of the following to reduce sound:
a low-density polyethylene;
a low stiffness plastic;
a natural rubber; or
a silicon rubber.

20. The method of claim 18, wherein the rotating the adjusting knob being rotating the adjusting knob in a first direction, the method further comprising:
rotating the adjusting knob in a second direction;
pushing, based in part on rotating the adjusting knob in the second direction, the wall against a shoulder of the rotating carrier, wherein the shoulder of the rotating carrier is adjacent a proximate end of the pawl; and
rotating, based at least in part on the wall pushing against the shoulder, the rotating carrier in the second direction.
